(19) United States
(12) Patent Application Publication
(10) Pub. No.: US 2025/0041967 A1
(43) Pub. Date: Feb. 6, 2025

(54) LASER PROCESSING APPARATUS

(71) Applicant: PlayNitride Display Co., Ltd., MiaoLi County (TW)

(72) Inventors: Yen-Mu Chen, MiaoLi County (TW); Chih-Chien Tung, MiaoLi County (TW); Zong Huei Tsai, MiaoLi County (TW)

(73) Assignee: PlayNitride Display Co., Ltd., MiaoLi County (TW)

(21) Appl. No.: 18/456,532

(22) Filed: Aug. 28, 2023

(30) Foreign Application Priority Data
Aug. 4, 2023 (TW) 112129286

(51) Int. Cl. B23K 26/06

(52) U.S. Cl. CPC B23K 26/0643

(57) ABSTRACT

A laser processing apparatus including a laser light source, a polarizing beam splitter, a first reflective mirror, a second reflective mirror, and a polarizing beam combiner is disclosed. The laser light source is configured to generate a laser light. The polarizing beam splitter is configured to divide the laser light into a first beam and a second beam. The first reflective mirror is configured to reflect the first beam. The second reflective mirror is configured to reflect the second beam. The polarizing beam combiner is disposed on a path of the first beam reflected by the first reflective mirror and on a path of the second beam reflected by the second reflective mirror. An optical axis of the polarizing beam combiner is not parallel to the first beam. The polarizing beam combiner is configured to guide the first beam and the second beam.

### CROSS-REFERENCE TO RELATED APPLICATION

This application claims the priority benefit of Taiwan application serial no. 112129286, filed on Aug. 4, 2023. The entirety of the above-mentioned patent application is hereby incorporated by reference herein and made a part of this specification.

### BACKGROUND

### Technical Field

This disclosure relates to a processing apparatus, and in particular to a laser processing apparatus.

### Description of Related Art

Among the various types of processing devices, laser processing apparatuses are able to focus energy on a specific location, which may include a specific location in the horizontal direction and a specific depth location, thus enabling precision processing of micro elements (e.g., micro light emitting diodes).

Known laser processing apparatuses usually utilize a laser beam to process an object to be processed, and a laser light source in the laser processing apparatus can be moved relative to a carrying platform used to carry the object to be processed to process different positions of the object to be processed or different objects to be processed. However, when the processing is performed by scanning the object to be processed with one laser beam, the processing time is limited by the scanning speed of the laser beam and it is difficult to shorten the processing time.

### SUMMARY

The disclosure provides a laser processing apparatus, capable of effectively shortening the processing time.

An embodiment of the disclosure proposes a laser processing apparatus including a laser light source, a polarizing beam splitter (PBS), a first reflective mirror, a second reflective mirror, a polarizing beam combiner, and a focusing element. The laser light source is configured to generate a laser light, and the polarizing beam splitter is configured to divide the laser light into a first beam and a second beam having different polarization states. The first beam passes through the polarizing beam splitter, and the second beam is reflected by the polarizing beam splitter. The first reflective mirror is configured to reflect the first beam, and the second reflective mirror is configured to reflect the second beam. The polarizing beam combiner is disposed on a path of the first beam reflected by the first reflective mirror and on a path of the second beam reflected by the second reflective mirror. An optical axis of the polarizing beam combiner is not parallel to the first beam. The polarizing beam combiner is configured to receive the first beam and the second beam, and guide the first beam and the second beam. The focusing element is disposed on a path of the first beam and the second beam guided by the polarizing beam combiner, and is configured to converge the first beam and the second beam and form a first speckle and a second speckle separated from each other respectively.

An embodiment of the disclosure proposes a laser processing apparatus including a laser light source, a polarizing beam splitter, a first reflective mirror, a second reflective mirror, a polarizing beam combiner, and a focusing element. The laser light source is configured to generate a laser light, and the polarizing beam splitter is configured to divide the laser light into a first beam and a second beam having different polarization states. The first beam passes through the polarizing beam splitter, and the second beam is reflected by the polarizing beam splitter. The first reflective mirror is configured to reflect the first beam, and the second reflective mirror is configured to reflect the second beam. The polarizing beam combiner is disposed on a path of the first beam reflected by the first reflective mirror and on a path of the second beam reflected by the second reflective mirror. An optical axis of the polarizing beam combiner is parallel to the first beam. The polarizing beam combiner is configured to receive the first beam and the second beam, and guide the first beam and the second beam. The focusing element is disposed on a path of the first beam and the second beam guided by the polarizing beam combiner, and is configured to converge the first beam and the second beam and form a first speckle and a second speckle separated from each other respectively. The first reflective mirror and the second reflective mirror are not parallel to each other.

In the laser processing apparatus of the embodiment of the disclosure, due to the design that the optical axis of the polarizing beam combiner is not parallel to the first beam, or the design that the first reflective mirror and the second reflective mirror are not parallel to each other, the first beam and the second beam emitted from the polarizing beam combiner are directed in different directions, and then are converged by the focusing element to form the first speckle and the second speckle separated from each other. The first speckle and the second speckle may be processed at different positions at the same time, thus doubling the effect of shortening the working time.

To make the aforementioned more comprehensive, several embodiments accompanied with drawings are described in detail as follows.

### BRIEF DESCRIPTION OF THE DRAWINGS

The accompanying drawings are included to provide a further understanding of the disclosure, and are incorporated in and constitute a part of this specification. The drawings illustrate exemplary embodiments of the disclosure and, together with the description, serve to explain the principles of the disclosure.

FIG. 1 is a schematic diagram of an optical path of a laser processing apparatus according to an embodiment of the disclosure.

FIG. 2 is a schematic cross-sectional diagram according to an embodiment of a polarizing beam combiner in FIG. 1.

FIG. 3 and FIG. 4 respectively show that an optical axis of a polarizing beam combiner is deflected in two different directions relative to a first beam.

FIG. 5 is a schematic diagram of a local optical path of the polarizing beam combiner and a focusing element in FIG. 1.

FIG. 6 is a schematic diagram of an optical path of a laser processing apparatus according to another embodiment of the disclosure.

FIG. 7 is a schematic diagram of a local optical path of a polarizing beam combiner and a focusing element of a laser processing apparatus according to another embodiment of the disclosure.

FIG. 8 is a schematic diagram of an optical path of a laser processing apparatus according to another embodiment of the disclosure.

### DESCRIPTION OF THE EMBODIMENTS

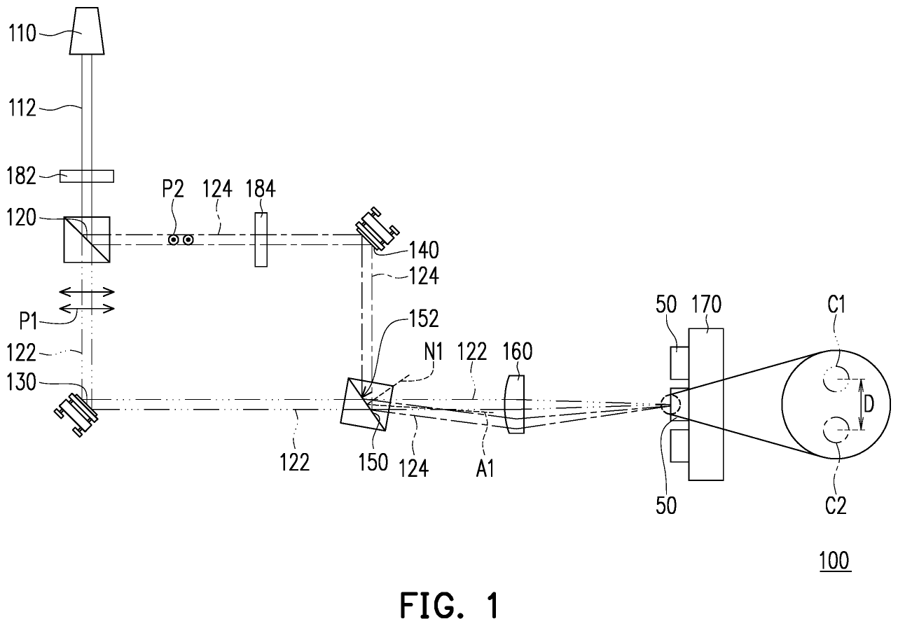

FIG. 1 is a schematic diagram of an optical path of a laser processing apparatus according to an embodiment of the disclosure. Referring to FIG. 1, a laser processing apparatus 100 of this embodiment includes a laser light source 110, a polarizing beam splitter 120, a first reflective mirror 130, a second reflective mirror 140, a polarizing beam combiner 150, and a focusing element 160. The laser light source 110 is configured to generate a laser light 112, and the polarizing beam splitter 120 is configured to divide the laser light 112 into a first beam 122 and a second beam 124 having different polarization states. The first beam 122 passes through the polarizing beam splitter 120, and the second beam 124 is reflected by the polarizing beam splitter 120. In this embodiment, the first beam 122 has a first polarization direction P1, the second beam 124 has a second polarization direction P2, the first polarization direction P1 is, for example, P polarization direction, and the second polarization direction P2 is, for example, S polarization direction.

The first reflective mirror 130 is configured to reflect the first beam 122, and the second reflective mirror 140 is configured to reflect the second beam 124. The polarizing beam combiner 150 is disposed on a path of the first beam 122 reflected by the first reflective mirror 130 and on a path of the second beam 124 reflected by the second reflective mirror 140. An optical axis A1 of the polarizing beam combiner 150 is not parallel to the first beam 122. The polarizing beam combiner 150 is configured to receive the first beam 122 and the second beam 124 and guide the first beam 122 and the second beam 124.

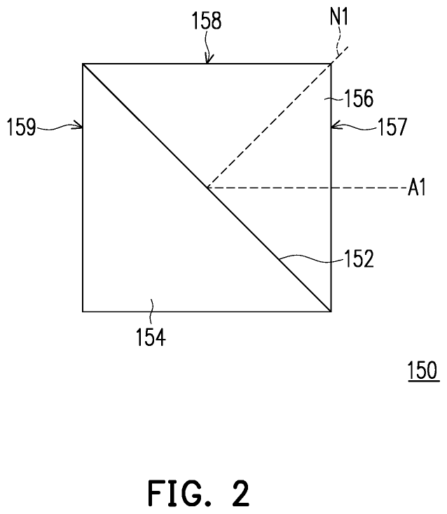

In this embodiment, the polarizing beam combiner 150 is a polarizing beam splitter having a polarizing beam splitting surface 152. The first beam 122 having the P polarization direction passes through the polarizing beam splitting surface 152, and the second beam 124 having the S polarization direction is reflected by the polarizing splitting surface 152. The optical axis A1 is defined as an axis intersecting 45 degrees with a normal NI of the polarizing beam splitting surface 152 and falling on a plane where the first beam 122 and the second beam 124 are located (as shown in FIG. 1). In one embodiment, as shown in FIG. 2, the polarizing beam combiner 150 may have a polarizing beam splitting surface located between two prisms 154 and 156, and the optical axis A1 is perpendicular to a surface 157 of the prism 156 facing away from the polarizing beam splitting surface 152. In this embodiment, the first beam 122 having the P polarization direction is incident on the prism 154 from a surface 159, passes through the polarization beam splitting surface 152, and then is emitted from the surface 157. The second beam 124 having the S polarization direction is incident on the prism 156 from a surface 158, is reflected by the polarizing beam splitting surface 152, and then is emitted from the surface 157, forming an effect of combining light.

The focusing element 160 is disposed on a path of the first beam 122 and the second beam 124 guided by the polarizing beam combiner 150, and is configured to converge the first beam 122 and the second beam 124 and form a first speckle C1 and a second speckle C2 separated from each other respectively. In this embodiment, the focusing element 160 is, for example, a lens.

In the laser processing apparatus 100 according to this embodiment, due to the design that the optical axis A1 of the polarizing beam combiner 150 is not parallel to the first beam 122, the first beam 122 and the second beam 124 emitted from the polarizing beam combiner 150 are directed in different directions, and then are converged by the focusing element 160 into the first speckle C1 and the second speckle C2 separated from each other. The first speckle C1 and the second speckle C2 may be processed at different positions at the same time, thus doubling the effect of shortening the working time.

Specifically, since the first beam 122 may pass through the polarizing beam combiner 150, no matter whether an incident angle relative to the first beam 122 is 45 degrees or other angles, the direction of the first beam 122 before passing through the polarizing beam combiner 150 and after passing through the polarizing beam combiner 150 does not change. In this embodiment, since the optical axis A1 is not parallel to the first beam 122, an incident angle of the second beam 124 to the polarizing beam combiner 150 (i.e., the incident angle to the polarization beam splitting surface 152) is greater than 45 degrees or less than 45 degrees. In this way, a reflection angle of the second beam 124 reflected by the polarizing beam combiner 150 is also different from 45 degrees, so that the first beam 122 and the second beam 124 are emitted from the polarizing beam combiner 150 in different directions. That is, the polarizing beam combiner 150 guides the first beam 122 and the second beam 124 to the focusing element 160 in a first direction (a direction in which the first beam 122 is emitted from the polarizing beam combiner) and a second direction (a direction in which the second beam 124 is emitted from the polarizing beam combiner) having an included angle. This cause the first beam 122 and the second beam 124 to irradiate at different positions of the focusing element 160, thus causing the focusing element 160 to converge at two different positions to form the first speckle C1 and the second speckle C2 respectively.

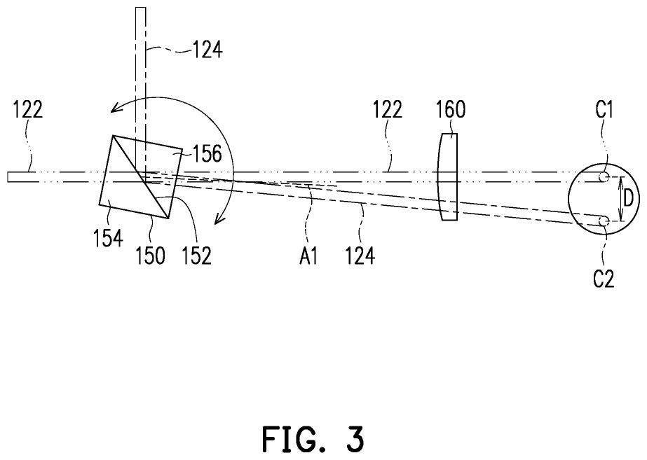

That is, in this embodiment, as shown in FIG. 3, the optical axis A1 of the polarizing beam combiner 150 is deflected relative to the first beam 122 with a rotation axis A2. The rotation axis A2 is perpendicular to the first beam 122 and the second beam 124.

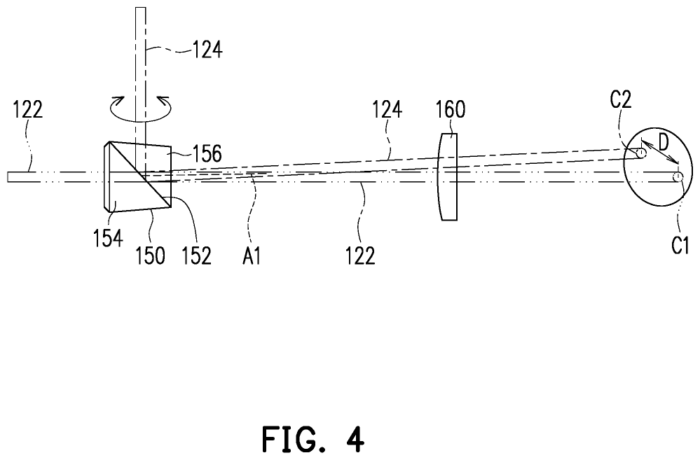

However, in another embodiment, as shown in FIG. 4, the optical axis A1 of the polarizing beam combiner 150 is deflected relative to the first beam 122 with the second beam 124 incident on the polarizing beam combiner 150 as an axis, so that the first speckle C1 and the second speckle C2 may be separated in a direction different from the direction of FIG. 3.

In this embodiment, the laser processing apparatus 100 further includes a carrying platform 170 to carry at least one micro light emitting device 50. The first speckle C1 and the second speckle C2 fall on the micro light emitting device 50. The carrying platform 170 carries one or more micro light emitting elements 50, and the first speckle C1 and the second speckle C2 may fall on different positions of the same micro light emitting element 50, or fall on two micro light emitting elements 50 respectively. In one embodiment, the micro light emitting element 50 is, for example, a micro light emitting diode, and the laser processing apparatus 100 is a micro light emitting diode transfer apparatus configured to strip the micro light emitting diode from the carrying platform, and a distance D between the first speckle C1 and the second speckle C2 is less than 10 microns. In addition, in one embodiment, a depth of focus of the first speckle C1 and the second speckle C2 formed by the focusing element 160 is greater than a height of the micro light emitting element 50, that is, the depth of focus may cover each height position of the micro light emitting element 50, and the effect of height error may also be eliminated, so that the energy density of the speckle is not reduced by too much due to the absence of the focal point. In addition, since the first beam 122 and the second beam 124 are from the same laser light 112, the first beam 122 and the second beam 124 may have the same or similar characteristics, and the processing effect on the object to be processed (e.g., the micro light emitting element 50) may also be the same. Therefore, compared to the difference caused by using two laser light sources to process two positions separately, the laser processing apparatus 100 of this embodiment may effectively reduce the processing difference between the two positions, i.e., reduce the difference in characteristics between the first speckle C1 and the second speckle C2.

In this embodiment, the optical axis A1 of the polarizing beam combiner 150 is deflected relative to the first beam 122 so that the first beam 122 and the second beam 124 are emitted in different directions. In this way, the positional offset of the beam on the optical path may be reduced, and the volume and size of each optical element may be reduced, compared with the optical path offset caused by the deflection of the first reflective mirror 130 or the second first reflective mirror 140, so that the first beam 122 or the second beam 124 has to be received by the larger polarizing beam combiner 150. In addition to cost savings, the smaller size of the element may also reduce the instability of the impact of the temperature and assembly tolerances. In addition, the direction of the beam may be changed closer to the focusing element 150, and the range of the two beams (i.e., the first beam 122 and the second beam 124) may be covered by the smaller focusing element at the same time.

In this embodiment, the laser processing apparatus 100 further includes a first phase retarder 182 disposed on a path of the laser light 112, located between the laser light source 110 and the polarizing beam splitter 120, and configured to change a ratio of the first beam 122 and the second beam 124 contained in the laser light 112. Specifically, the first phase retarder 182 may be rotated on the axis of the laser light 112, and since the laser light 112 has a certain degree of polarization, rotating the first phase retarder 182 may change the polarization direction of the laser light 112, which also changes the S polarization component and the P polarization component of this polarization direction, and further changes the ratio of the light intensity of the first beam 122 having the P polarization component to the light intensity of the second beam 124 having the S polarization component.

In this embodiment, the laser processing apparatus 100 further includes a second phase retarder 184 disposed on a second optical path between the polarizing beam splitter 120, the second reflective mirror 140, and the polarizing beam combiner 150, and configured to generate a phase difference to the second beam 124. The second phase retarder 184 may rotate on the second beam 124 passing through the second phase retarder 184 as an axis to change the second polarization direction P2 (i.e., the S polarization direction) of the second beam 124 into other polarization directions, which is equivalent to changing the S polarization component and the P polarization component of the second beam 124, and the portion of the second beam 124 having the S polarization direction may be reflected by the polarization combiner 150 to form the second speckle C2, whereas the portion of the second beam 124 having the P polarization direction may pass through the polarization combiner 150 and become stray light. Thus, the light intensity of the second speckle C2 may be adjusted by changing the S polarization component as the second phase retarder 184 is rotated. By rotating the first phase retarder 182 and the second phase retarder 184, the light intensities of the first speckle C1 and the second speckle C2 may be adjusted to any combination of light intensities, or be well adjusted so that the light intensities of the two speckles are equal. In FIG. 1, the second phase retarder 184 is shown as being disposed between the polarizing beam splitter 120 and the second reflective mirror 140. However, in other embodiments, the second phase retarder 184 may also be disposed between the second reflective mirror 140 and the polarizing beam combiner 150. In addition, in other embodiments, instead of using the first phase retarder 182, the laser light source 110 may be rotated on the laser light 112 as an axis, so that the polarization direction of the laser light 112 may also be changed to change the ratio of the light intensity of the first beam 122 to the light intensity of the second light beam 124.

In this embodiment, an optical path length of a first optical path between the polarizing beam splitter 120, the first reflective mirror 130, and the polarizing beam combiner 150 is the same as an optical path length of the second optical path between the polarizing beam splitter 120, the second reflective mirror 140, and the polarizing beam combiner 150, so that there is no time difference between the formation time of the first speckle C1 and the second speckle C2.

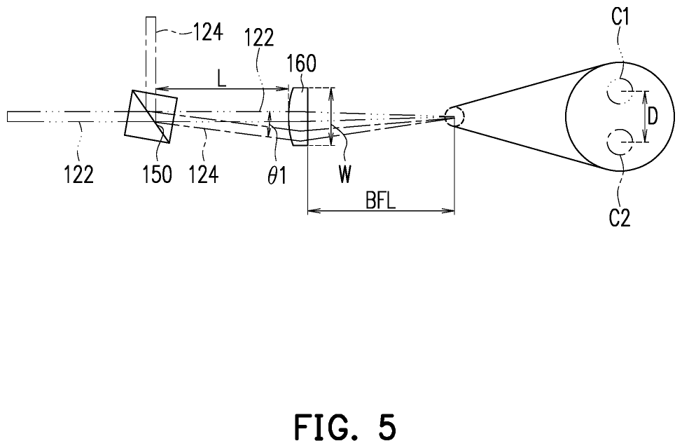

FIG. 5 is a schematic diagram of a local optical path of the polarizing beam combiner and a focusing element in FIG. 1. Referring to FIG. 1 and FIG. 5, in this embodiment, a light-receiving aperture W of the focusing element 160 is greater than a product of an included angle θ1 between the first beam 122 and the second beam 124 and a light-receiving distance L. The light-receiving distance L is a distance from the polarizing beam combiner 150 to the focusing element 160. In this way, both the first beam 122 and the second beam 124 may be collected into the focusing element 160. In addition, in this embodiment, the distance D between the first speckle C1 and the second speckle C2 is greater than 2.44λ (f/#), where λ is a wavelength of the laser light 112, and f/# is an aperture value of the focusing element 160. Since the lower limit of the speckle size is determined by the diffraction limit, the speckle size is limited by the above condition to be less than the expected separation distance D of the two speckles, so as to avoid the occurrence of partial overlapping of the two speckles. In addition, f/# is defined as BFL/W, where BFL is a back focal length of the focusing element 160, i.e., a distance from the focusing element 160 to the first speckle C1 or the second speckle C2.

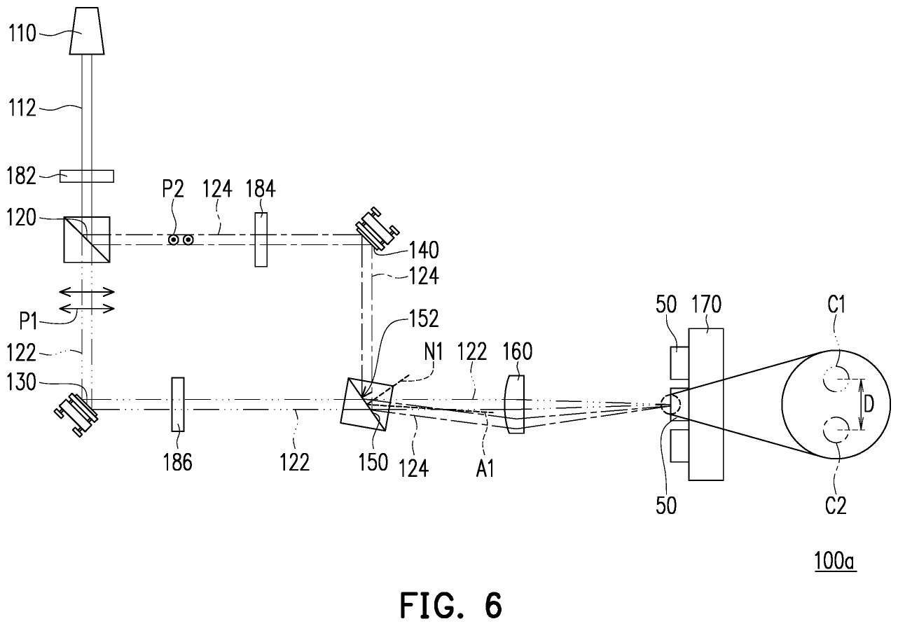

FIG. 6 is a schematic diagram of an optical path of a laser processing apparatus according to another embodiment of the disclosure. Referring to FIG. 6, a laser processing apparatus 100a of this embodiment is similar to the laser processing apparatus 100 of FIG. 1. The main difference between the two is that the laser processing apparatus 100a of this embodiment further include a third phase retarder 186 disposed on the first optical path between the polarizing beam splitter 120, the first reflective mirror 130, and the polarizing beam combiner 150, and configured to generate a phase difference to the first beam 122. The third phase retarder 186 may rotate on the first beam 122 passing through the third phase retarder 186 as an axis to change the first polarization direction P1 (i.e., the P polarization direction) of the first beam 122 into other polarization directions, which is equivalent to changing the S polarization component and the P polarization component of the first beam 122, and the portion of the first beam 122 having the P polarization direction may pass through the polarization combiner 150 to form the first speckle C1, whereas the portion of the first beam 122 having the S polarization direction may be reflected by the polarization combiner 150 and become stray light. Thus, the light intensity of the first speckle C1 may be adjusted by changing the P polarization component as the third phase retarder 186 is rotated. That is, by rotating the second phase retarder 184 and the third phase retarder 186, the light intensities of the first speckle C1 and the second speckle C2 may be adjusted to any combination of light intensities, or be well adjusted so that the light intensities of the two speckles are equal.

In FIG. 6, the third phase retarder 186 is disposed between the first reflective mirror 130 and the polarizing beam combiner 150. However, in other embodiments, the third phase retarder 186 may also be disposed between the polarizing beam splitter 120 and the first reflective mirror 130.

In the above embodiments, the first phase retarder 182, the second phase retarder 184, and the third phase retarder 186 may be half-wave plates, quarter-wave plates, one-eighth-wave plates, other wave plates, or a combination thereof, and they may be formed of a birefringent material.

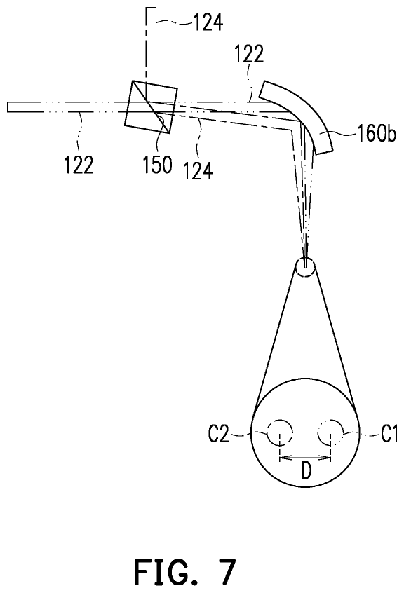

FIG. 7 is a schematic diagram of a local optical path of a polarizing beam combiner and a focusing element of a laser processing apparatus according to another embodiment of the disclosure. Referring to FIG. 7, the local optical path of the laser processing apparatus of this embodiment is similar to the local optical path of the laser processing apparatus 100 of FIG. 5. The main difference between the two is that in this embodiment, a focusing element 160b is a concave reflective mirror reflecting and converging the first beam 122 and the second beam 124 into the first speckle C1 and the second speckle C2 respectively.

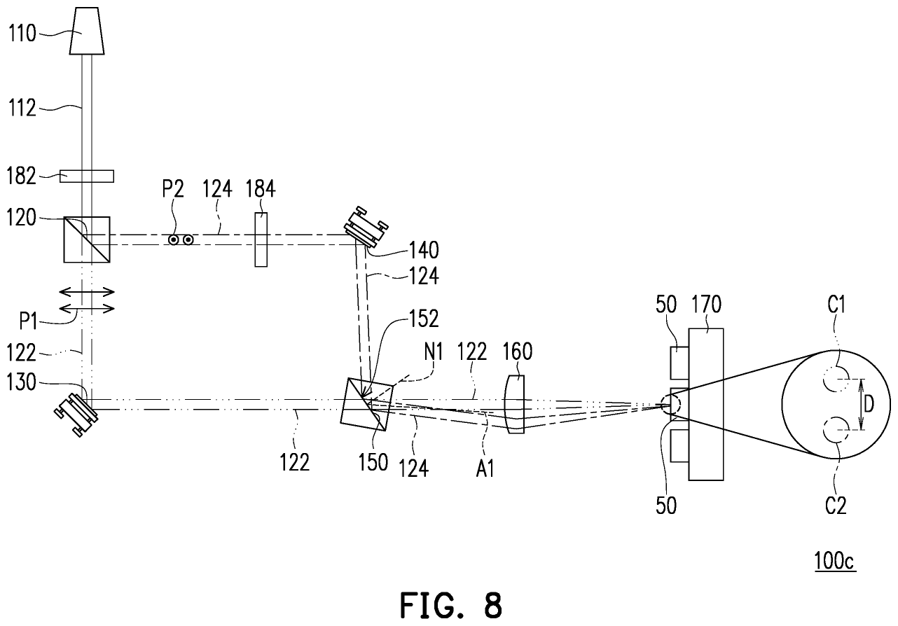

FIG. 8 is a schematic diagram of an optical path of a laser processing apparatus according to another embodiment of the disclosure. Referring to FIG. 8, a laser processing apparatus 100c of this embodiment is similar to the laser processing apparatus 100 of FIG. 1. The main difference between the two is that in the laser processing apparatus 100c of this embodiment, the first reflective mirror 130 and second reflective mirror 140 are not parallel to each other, so that an included angle between the first beam 122 and the second beam 124 emitted from the polarizing beam combiner 150 may be enlarged, and thus the distance D between the first speckle C1 and the second speckle C2 may be increased. In some embodiments, the optical axis of the polarizing beam combiner 150 is parallel to the first beam 122 before being incident, and the second reflective mirror 140 is disposed to be not parallel to the first reflective mirror 130, so that the direction of the second beam 124 after being reflected by the polarizing beam combiner 150 (i.e., the polarizing splitting surface 152) is not parallel to the first beam 122, which is then converged into the first speckle C1 and the second speckle C2 by the focusing element 160, respectively. In this embodiment, the first beam 122 and the second beam 124 pass through the polarizing beam splitter 120, the polarizing beam combiner 150, and the first reflective mirror 130 or the second reflective mirror 140 an equal number of times, the degree of loss caused by the above elements is equal, and the length of the path is also the same, so as to reduce the difference between the energy of the first speckle C1 and the second speckle C2. In contrast, in the laser processing apparatus 100 shown in FIG. 1, the first reflective mirror 130 and the second reflective mirror 140 may be disposed parallel to each other.

To sum up, in the laser processing apparatus of the embodiment of the disclosure, due to the design that the optical axis of the polarizing beam combiner is not parallel to the first beam, or the design that the first reflective mirror and the second reflective mirror are not parallel to each other, the first beam and the second beam emitted from the polarizing beam combiner are directed in different directions, and then are converged by the focusing element to form the first speckle and the second speckle separated from each other. The first speckle and the second speckle may be processed at different positions at the same time, thus doubling the effect of shortening the working time.

It will be apparent to those skilled in the art that various modifications and variations can be made to the disclosed embodiments without departing from the scope or spirit of the disclosure. In view of the forthcoming, it is intended that the disclosure covers modifications and variations provided that they fall within the scope of the following claims and their equivalents.

What is claimed is:

1. A laser processing apparatus comprising:
a laser light source configured to generate a laser light;
a polarizing beam splitter configured to divide the laser light into a first beam and a second beam having different polarization states, wherein the first beam passes through the polarizing beam splitter, and the second beam is reflected by the polarizing beam splitter;
a first reflective mirror configured to reflect the first beam;
a second reflective mirror configured to reflect the second beam;
a polarizing beam combiner disposed on a path of the first beam reflected by the first reflective mirror and on a path of the second beam reflected by the second reflective mirror, wherein an optical axis of the polarizing beam combiner is not parallel to the first beam, the polarizing beam combiner is configured to receive the first beam and the second beam, and guide the first beam and the second beam; and
a focusing element disposed on a path of the first beam and the second beam guided by the polarizing beam combiner, and configured to converge the first beam and the second beam and form a first speckle and a second speckle separated from each other respectively.

2. The laser processing apparatus according to claim 1, wherein the optical axis of the polarizing beam combiner is deflected relative to the first beam with a rotation axis, wherein the rotation axis is perpendicular to the first beam and the second beam.

3. The laser processing apparatus according to claim 1, wherein the optical axis of the polarizing beam combiner is deflected relative to the first beam with the second beam incident on the polarizing beam combiner as an axis.

4. The laser processing apparatus according to claim 1, wherein the polarizing beam combiner guides the first beam and the second beam to the focusing element in a first direction and a second direction having an included angle.

5. The laser processing apparatus according to claim 1, wherein an incident angle of the second beam to the polarizing beam combiner is greater than 45 degrees or less than 45 degrees.

6. The laser processing apparatus according to claim 1, wherein the first reflective mirror and the second reflective mirror are not parallel to each other.

7. The laser processing apparatus according to claim 1 further comprising a first phase retarder disposed on a path of the laser light, and located between the laser light source and the polarizing beam splitter to change a ratio of the first beam and the second beam contained in the laser light.

8. The laser processing apparatus according to claim 7 further comprising a second phase retarder disposed on a second optical path between the polarizing beam splitter, the second reflective mirror, and the polarizing beam combiner, and configured to generate a phase difference to the second beam.

9. The laser processing apparatus according to claim 7 further comprising a third phase retarder disposed on a first optical path between the polarizing beam splitter, the first reflective mirror, and the polarizing beam combiner, and configured to generate a phase difference to the first beam.

10. The laser processing apparatus according to claim 1, wherein an optical path length of a first optical path between the polarizing beam splitter, the first reflective mirror, and the polarizing beam combiner is the same as an optical path length of a second optical path between the polarizing beam splitter, the second reflective mirror, and the polarizing beam combiner.

11. The laser processing apparatus according to claim 1, wherein the focusing element is a lens or a concave reflective mirror.

12. The laser processing apparatus according to claim 1, wherein the laser processing apparatus is a micro light emitting diode transfer apparatus, and a distance between the first speckle and the second speckle is less than 10 microns.

13. The laser processing apparatus according to claim 1 further comprising a carrying platform configured to carry at least one micro light emitting element, wherein the first speckle and the second speckle fall on the at least one micro light emitting element.

14. The laser processing apparatus according to claim 13, wherein a depth of focus of the first speckle and the second speckle formed by the focusing element is greater than a height of the micro light emitting element.

15. The laser processing apparatus according to claim 1, wherein a light-receiving aperture of the focusing element is greater than a product of an included angle between the first beam and the second beam and a light-receiving distance, and the light-receiving distance is a distance from the polarizing beam combiner to the focusing element.

16. The laser processing apparatus according to claim 1, wherein a distance between the first speckle and the second speckle is greater than 2.44λ (f/#), wherein λ is a wavelength of the laser light, and f/# is an aperture value of the focusing element.

17. A laser processing apparatus comprising:
a laser light source configured to generate a laser light;
a polarizing beam splitter configured to divide the laser light into a first beam and a second beam having different polarization states, wherein the first beam passes through the polarizing beam splitter, and the second beam is reflected by the polarizing beam splitter;
a first reflective mirror configured to reflect the first beam;
a second reflective mirror configured to reflect the second beam;
a polarizing beam combiner disposed on a path of the first beam reflected by the first reflective mirror and on a path of the second beam reflected by the second reflective mirror, wherein an optical axis of the polarizing beam combiner is parallel to the first beam, the polarizing beam combiner is configured to receive the first beam and the second beam, and guide the first beam and the second beam; and
a focusing element disposed on a path of the first beam and the second beam guided by the polarizing beam combiner, and configured to converge the first beam and the second beam and form a first speckle and a second speckle separated from each other respectively,
wherein the first reflective mirror and the second reflective mirror are not parallel to each other.
